(19) United States
(12) Patent Application Publication
(10) Pub. No.: US 2006/0261581 A1
(43) Pub. Date: Nov. 23, 2006

(54) Instrument panel

(76) Inventors: Udo Kansteiner, Witten (DE); Jens Hannemann, Berlin (DE)

Correspondence Address: DELPHI TECHNOLOGIES, INC., M/C 480-410-202, PO BOX 5052, TROY, MI, 48007, US

(21) Appl. No.: 11/399,186

(22) Filed: Apr. 6, 2006

(30) Foreign Application Priority Data
May 19, 2005 (EP) 05010860.4

(51) Int. Cl. B60R 21/205; B60R 21/26

(52) U.S. Cl. 280/732; 280/728.2; 280/740

(57) ABSTRACT

The invention relates to an instrument panel for a motor vehicle comprising a firing channel for an inflating airbag, with the firing channel simultaneously forming an airbag housing in which the airbag is accommodated in the folded state, and with a gas generator for the inflation of the airbag being attached to the airbag housing separately from the airbag and in a gas-tight manner. The invention furthermore relates to a method for the installation of an airbag module to a motor vehicle instrument panel.

### TECHNICAL FIELD

The invention relates to an instrument panel for a motor vehicle comprising a firing channel for an inflating airbag.

### BACKGROUND OF THE INVENTION

An instrument panel of this type is generally known. The firing channel serves to steer the inflating airbag into a predetermined direction and thereby to ensure the deployment of the airbag in a desired deployment direction.

Typically, a complete airbag module, in which the airbag and a gas generator for the inflation of the airbag are combined to form a unit, is attached to the instrument panel. The fastening of the airbag module requires a sufficiently stable carrier structure not only at the instrument panel, but also at the airbag module itself. For this reason, a known airbag module typically has a metal casing which can be fastened, e.g. screwed, to the carrier structure of the instrument panel.

The handling and in particular the installation of an airbag module of this type does not only prove to be problematic for reasons of weight, but there is also increased danger on an unintentional release of the airbag module.

Furthermore, the gas generator must be replaced for servicing purposes approximately every 10 to 12 years. Due to the unit of airbag and gas generator, every replacement of the gas generator requires a disassembly of the total airbag module from the instrument panel, which is associated with a substantial cost expense.

### SUMMARY OF THE INVENTION

It is the underlying object of the invention to provide an instrument panel which permits a simpler and safer installation as well as a more cost-favorable servicing of an airbag module.

An instrument panel having the features of claim 1 is provided to satisfy this object.

The instrument panel in accordance with the invention includes a firing channel for an inflating airbag, with the firing channel simultaneously forming an airbag housing in which the airbag is accommodated in the folded state, and with a gas generator for the inflation of the airbag being attached to the airbag housing separately from the airbag and in a gas-tight manner.

In accordance with the invention, the airbag and the gas generator are therefore not accommodated in a common housing, but represent separate components which are each installed at the instrument panel separately from one another.

The airbag is thus accommodated in an airbag housing which is formed by the firing channel. In other words, the firing channel satisfies a dual function in that it forms a housing for the airbag, on the one hand, and thereby holds the airbag at the instrument panel and protects it from outer influences and, on the other hand, ensures a deployment of the inflating airbag in a desired deployment direction.

The gas generator and the airbag can be attached to the instrument panel independently of one another due to the fastening of the gas generator to the airbag housing separately from the airbag. The installation of the components of the airbag module to the instrument panel is thereby substantially facilitated.

When a replacement of the gas generator is necessary, the gas generator only has to be released from the airbag housing, whereas the folded airbag can remain in the airbag housing. The servicing of the gas generator can thus be carried out substantially more easily and with a lower financial effort.

Since the airbag and the gas generator are attached to the instrument panel separately from one another, the risk of an unintentional inflation of the airbag during the installation is also minimized. This not only results in an avoidance of additional costs which result from an unintended triggering of the airbag during the installation, but also in increased safety for the installation personnel, since the instrument panel with a pre-installed airbag does not represent a hazardous good and the gas generator alone has a substantially lower recoil than a module with an airbag on an unintentional triggering. The risk of injury is thereby substantially reduced.

Advantageous embodiments of the instrument panel in accordance with the invention can be seen from the dependent claims, from the description and from the drawing.

In accordance with a preferred embodiment, the firing channel is formed by a separate channel shaped part. This makes it possible to arrange the folded airbag in the firing channel initially and subsequently to attach the channel shaped part to the instrument panel together with the airbag accommodated in it. The forming of the firing channel at the instrument panel and the attachment of the folded airbag in other words take place in one workstep.

The channel shaped part can comprise a plastic material and in particular be an injection molded plastic part. If the instrument panel also comprises a plastic material at least at its side facing the channel shaped part, the instrument panel and the channel shaped part can be connected to one another by means of a weld connection. The attachment of the airbag module to the instrument panel is thereby made even simpler.

The channel shaped part advantageously additionally forms at least one ventilation passage. A channel shaped part of this type represents a multifunctional part in that it not only forms a firing channel and a housing for the airbag but also forms a ventilation passage. A separate ventilation passage structure is thus superfluous. Alternatively, the airbag guidance and the ventilation passage can also be separate from one another.

In accordance with a further embodiment, the gas generator is attached in the region of a gas supply opening of the airbag housing for the supply of gas to the airbag. In this manner, the gas being discharged from the gas generator covers a minimal path on the way into the airbag. This permits a particularly fast inflation of the airbag.

A seal is advantageously provided between the gas generator and the airbag housing and/or between the gas generator and a fastening means for the fastening of the gas generator to the airbag housing. The seal contributes to the gas being discharged from the gas generator being able to enter into the airbag in a particularly low-loss manner. The airbag can thereby be inflated particularly efficiently.

At least one sealing rib is preferably provided at the outside of the airbag housing and surrounds a gas supply opening of the airbag housing in the manner of a ring for the supply of gas to the airbag. A sealing rib of this type represents a particularly simple and effective form of sealing.

In accordance with a further embodiment, the gas generator is fastened to the airbag housing by means of a clamp. This permits a particularly simple and cost-favorable installation or disassembly of the gas generator at or from the airbag housing. A gas generator which has a cylindrical shape can in particular be fastened easily to the airbag housing by the clamp.

The clamp advantageously surrounds the gas generator in the region of gas discharge openings of the gas generator. The clamp thereby prevents a discharge of the gas in an undesired direction and thus contributes to an even more efficient inflation of the airbag.

The clamp preferably forms a gas passage in order to guide gas being discharged from the gas generator to a gas supply opening of the airbag housing. Gas which is discharged at different positions of the gas generator, for example from a plurality of gas discharge openings arranged distributed over the periphery of a cylindrical gas generator, is therefore channeled by the clamp and guided to the gas supply opening and thus ultimately into the airbag. This permits an even faster and more efficient inflation of the airbag.

A section of the clamp contacting the gas generator can in each case be provided with at least one sealing rib. In this manner, the clamp is sealed with respect to the gas generator and an unwanted escape of gas from the gas passage is effectively prevented.

A further subject of the invention is a method of installing an airbag module to a motor vehicle instrument panel having the features of claim 13.

In the method in accordance with the invention, a folded airbag is accommodated in an airbag housing formed by a channel shaped part and simultaneously serving as a firing channel for the inflating airbag, the channel shaped part being fixedly connected to the instrument panel, and subsequently a gas generator for the inflation of the airbag is applied to the airbag housing separately from the airbag and in a gas-tight manner.

The method in accordance with the invention permits a particularly simple and cost-favorable installation of the airbag module to the instrument panel, since neither a separate airbag housing, e.g. a common housing for the airbag and the gas generator, is needed nor do the airbag and the gas generator have to be handled jointly as a unit. The risk of an unintentional inflation of the airbag in the installation is also minimized by the separate installation of the airbag and the gas generator. The fastening of the gas generator to the airbag housing independently of the airbag moreover facilitates a replacement of the gas generator, for example for servicing purposes.

### BRIEF DESCRIPTION OF THE DRAWINGS

The invention will be described in the following purely by way of example with reference to an advantageous embodiment and to the drawing. There are shown:

FIG. 1 is a cross-sectional view of an instrument panel in accordance with the invention; and

FIG. 2 is a cross-sectional view of a gas generator fastened to an airbag housing of the instrument panel of FIG. 1.

### DESCRIPTION OF THE PREFERRED EMBODIMENT

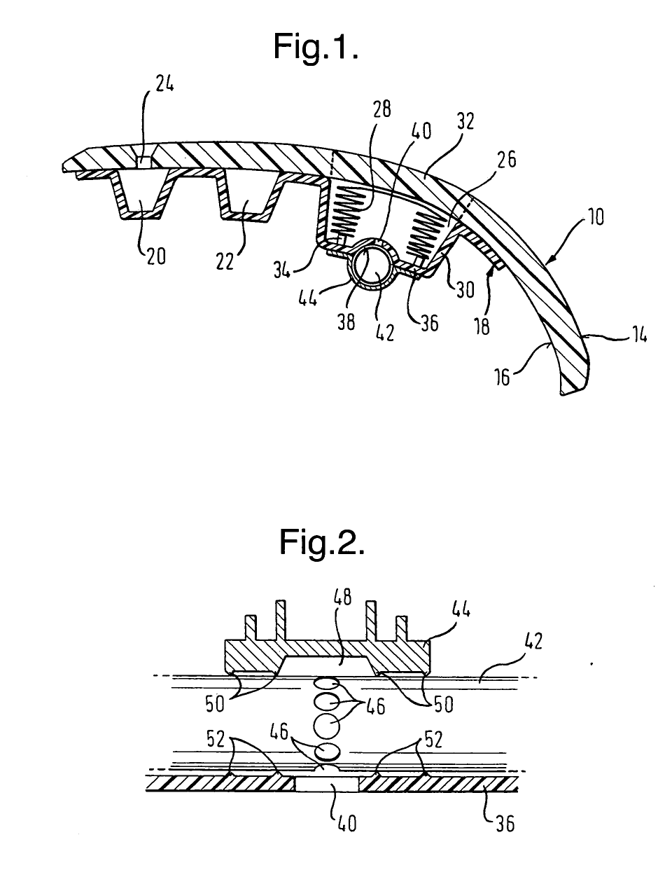

An instrument panel 10 in accordance with the invention for a motor vehicle is shown in FIG. 1. The instrument panel 10 includes a front side 14 facing in the direction of the interior of the vehicle and a rear side 16 remote from the interior of the vehicle. In the present embodiment, the instrument panel 10 is formed of a plastic material; generally, however, different materials can also be considered.

A channel shaped part 18 is fixedly connected to the instrument panel 10 at the rear side 16. In the present embodiment, the channel shaped part 18 is an injection molded plastic part; generally, however, the channel shaped part 18 can also be made of another material or by another method.

The channel shaped part 18 and the instrument panel 10 are welded to one another in the embodiment shown. Alternatively, the channel shaped part 18 can, however, also be connected to the instrument panel 10 in another manner, for example by means of an adhesive connection or a screw connection.

The channel shaped part 18 has two (alternatively integrated) ventilation passage 20, 22 by which fresh air or hot air can be guided into an interior space of a vehicle. In FIG. 1, a ventilation opening 24 of the instrument panel 10 is shown by way of example through which the fresh air or hot air can flow from the ventilation passage 20 into the interior space of the vehicle.

The channel shaped part 18 furthermore forms a firing channel 26 in which a folded airbag 28 is accommodated. The firing channel 26 does not only serve to steer the inflating airbag 28 into a desired deployment direction, but simultaneously also forms a housing 30 for the folded airbag 28. So that the airbag 28 can unfold as fast as possible in the event of an accident and can be discharged from the airbag housing 30, the instrument panel 10 has a cover section 32 which can be displaced, and in particular flipped open, by the airbag 28 and which closes the airbag housing 30 in the normal case.

The airbag 28 is anchored in a known manner to a base 36 of the airbag housing 30 by means of a holding ring 34. For example, latch elements (not shown) of the holding ring 34 can latch into correspondingly formed latch openings of the housing base 36.

The base 36 of the airbag housing 30 has an approximately semi-cylindrical recess 38 at whose center a gas supply opening 40 is located which permits the supply of gas being discharged from a gas generator 40 into the airbag 28.

The gas generator 42 in the embodiment shown has a cylindrical shape and is arranged in the cylindrical recess 38. The gas generator 42 is fixed to the base 36 of the airbag housing 30 from the outside by means of a clamp 44. The clamp 44 can, for example, be fastened to the airbag housing 30 by means of a screw connection.

As FIG. 2 shows, the clamp 44 surrounds the gas generator 42 in a region in which a plurality of gas discharge openings 46 of the gas generator 42 are arranged distributed over the periphery of the gas generator 42. The gas discharge openings 46 of the gas generator 42 are located in the region of the gas supply opening 40 and are preferably aligned with it.

The clamp 44 does not contact the gas generator 42 over the whole area, but rather forms a gas passage 48 extending in the peripheral direction of the gas generator 42 in the region of the gas discharge openings 46 in order to guide gas being discharged from the gas discharge openings 46 to the gas supply opening 40 of the airbag housing 30.

To prevent an unintended escaping of gas from the gas passage 48, the clamp 44 has two respective sealing ribs 50 at both sides of the gas passage 48 which are spaced apart from one another, which extend parallel to the gas passage 48 and which cooperate with the outer side of the gas generator 42.

Furthermore, two sealing ribs 52 are provided at the outer side of the housing base 36 which surround the gas supply opening 40 of the airbag housing 30 in the form of concentric rings to prevent an unintentional escaping of gas being discharged from the gas generator 42 in the region between the gas generator 42 and the airbag housing 30.

The sealing ribs 50 of the clamp 44 are pressed toward the gas generator 42 and the gas generator 42 is pressed toward the sealing ribs 52 of the housing base 36 by the fastening of the clamp 44 to the airbag housing 30. The gas passage 48 of the clamp 44 thereby forms a space with the interior of the airbag 28 via the gas supply opening 40 which space is closed in a substantially gas-tight manner and which permits a fast and efficient inflation of the airbag 28 on an activation of the gas generator 42. The expression “substantially gas-tight” in the framework of this application means that at least not so much gas can unintentionally escape that the inflation of the airbag 28 would be significantly impaired thereby.

For the installation of the airbag module to the instrument panel 10, the airbag 28 is first folded and inserted into the firing channel 26 of the channel shaped part 18 which at this time is still a separate component and is not connected to the instrument panel 10. The fixing of the airbag 28 to the channel shaped part 18 takes place by latching of the holding ring 34 to the base 36 of the airbag housing section of the channel shaped part 18.

Subsequently, the channel shaped part 18 is connected, e.g. welded, to the instrument panel 10. The channel shaped part 18 is positioned with respect to the instrument panel 10 such that the ventilation opening 24 of the instrument panel 10 is located in the region of the associated ventilation passage 20 of the channel shaped part 18 and the airbag housing 30 is closed by the cover section 32 of the instrument panel 10 which can be opened and which can in particular be flipped open.

The gas generator 42 is then attached to the airbag housing 30 from the outside and is fixed to the base 36 of the airbag housing 30 by means of a clamp 44 such that the gas discharge openings 46 of the gas generator 42 are aligned with the gas supply opening 40. The gas generator 42 is pressed so tightly onto the airbag housing 30 by the clamp 44 that the sealing ribs 50 of the clamp 44 and the sealing ribs 52 of the housing base 36 provide a substantially gas-tight connection of the gas generator 42 and the airbag housing 30.

1. An instrument panel for a motor vehicle comprising a firing channel for an inflating airbag, with the firing channel simultaneously forming an airbag housing in which the airbag is accommodated in the folded state, and with a gas generator for the inflation of the airbag being attached to the airbag housing separately from the airbag and in a gas-tight manner.

2. An instrument panel in accordance with claim 1, wherein the firing channel is formed by a separate channel shaped part.

3. An instrument panel in accordance with claim 2, wherein the channel shaped part is fixedly connected to the instrument panel by means e.g. of a weld connection.

4. An instrument panel in accordance with claim 2, wherein the channel shaped part defines at least one ventilation passage.

5. An instrument panel in accordance with claim 1, wherein the gas generator is attached to an outer side of the airbag housing.

6. An instrument panel in accordance with claim 1, wherein the gas generator is attached in the region of a gas supply opening of the airbag housing for the supply of gas to the airbag.

7. An instrument panel in accordance with claim 1, further comprising a seal disposed between the gas generator and the airbag housing and/or between the gas generator and a fastening means for the fastening of the gas generator to the airbag housing.

8. An instrument panel in accordance with claim 1, wherein at least one sealing surface to the gas generator, in particular a sealing rib, is provided at the outer side of the airbag housing and surrounds a gas supply opening of the airbag housing for the supply of gas to the airbag in the manner of a ring.

9. An instrument panel in accordance with claim 1, wherein the gas generator is fastened to the airbag housing by means of a clamp.

10. An instrument panel in accordance with claim 9, wherein the clamp surrounds the gas generator in the region of the gas discharge openings of the gas generator.

11. An instrument panel in accordance with claim 9, wherein the clamp forms a gas passage in order to guide gas being discharged from the gas generator to a gas supply opening of the airbag housing.

12. An instrument panel in accordance with claim 9, wherein a section of the clamp contacting the gas generator is provided with at least one respective sealing surface, in particular with a sealing rib.

13. A method for the installation of an airbag module to a motor vehicle instrument panel,
wherein a folded airbag is accommodated in an airbag housing formed by a channel shaped part and simultaneously serving as a firing channel for the inflating airbag;
the channel shaped part is fixedly connected to the instrument panel; and
a gas generator for the inflation of the airbag is subsequently attached to the airbag housing separately from the airbag and in a gas-tight manner.
